(19) United States
(12) Patent Application Publication
(10) Pub. No.: US 2004/0119449 A1
(43) Pub. Date: Jun. 24, 2004

(54) High power factor inverter for electronic loads & other DC sources

(76) Inventor: J. Brian Matley, Camarillo, CA (US)

Correspondence Address: J. BRIAN MATLEY, 2405 BARBARA DRIVE, CAMARILLO, CA, 93012, US

(21) Appl. No.: 10/327,802

(22) Filed: Dec. 19, 2002

(51) Int. Cl. G05F 1/10

(52) U.S. Cl. 323/234

(57) ABSTRACT

A multi-stage switch-mode DC to AC power inverter for electronic loads and other DC sources. The design comprises 3 stages of power conversion. The first two stages provide a DC-to-DC boost converter followed by a transformer coupled DC-to-DC forward converter. These 2 stages may be combined to reduce component count. The final stage is a unique DC to AC buck inverter that returns all of the available energy to the AC line with near unity power factor. This combination is designed with high efficiency operation for energy conservation and retrieval.

### BACKGROUND OF THE INVENTION

Resistive and Electronic Loads are widely used to burn-in DC power supplies. Electronic Loads replaced most resistive loads in the last 2 decades of the 20^{th} century. These electronic loads are much more versatile than resistive loads and operate over a wide range of voltages and currents. The more sophisticated mid-power electronic loads for test purposes have multiple load inputs and typically operate from 2 VDC to 60 VDC with a maximum current of 60 Amps and maximum power of 300 watts per load. They offer alternative modes of operation: constant current, constant resistance, constant voltage and constant power. They also offer dual load current functions with automatic switching between the 2 loads at a pre-selected variable frequency and duty ratio. The electronic loads used for burn-in are generally very simple constant current loads with the voltage, current and power levels customized to the requirements of the power supply manufacturer.

All these loads dissipate the energy by passing a continuous current through a transistor or bank of transistors attached to a heat sink assembly. The energy is converted to heat and forced air is normally used to dissipate the heat for loads under 500 watts. Liquid cooling may be used for higher power. They are classified as linear loads and are inherently low noise generators. FIG. 1 shows a basic linear electronic load.

The purpose of this invention is to provide a family of DC to AC inverters to transfer the energy from any low voltage DC power source to the AC line while maintaining a near unity power factor. The original concept was to return the major portion of the energy normally dissipated by an electronic load to the AC line. This conserves energy and reduces the cost of electricity used for burn-in and load tests. It is estimated that the savings on electricity during burn-in should pay for the cost of the load within 2 years. This estimate assumes 12 full days of burn-in per month. The 2 year time period will reduce as the cost of electricity rises.

### SUMMARY

This invention describes a method for transferring the energy from any low voltage DC source (LVDC) to the AC line while maintaining near unity power factor. The LVDC source is generally less than but not limited to 120 VDC. The invention was created specifically for electronic loads for DC power supplies but also applies to any DC power source. The primary goal of the invention is energy conservation and retrieval.

FIG. 2 shows a block diagram of the basic design, which requires 3 stages of electrical power conversion with transformer isolation. Stage 1 converts any low voltage DC input to a constant intermediate DC voltage. Stage 2 converts the intermediate DC voltage into high DC voltage with transformer isolation. This high voltage must be slightly higher than the peak of the maximum applied AC line voltage. Stage 3 is an inverter that converts the high voltage DC energy to AC energy and returns it to the line with near unity power factor.

Alternative designs combining stages 1 and 2 are shown in FIGS. 7 & 8.

### DESCRIPTION OF DRAWINGS

FIG. 1 shows a basic linear electronic load of current and prior art.

FIG. 2 shows a block diagram of a 3-stage switch-mode DC to AC inverter.

FIG. 3 shows a DC-to-DC boost converter suitable for the stage 1 conversion.

FIG. 4 shows a Half-Bridge forward converter suitable for the stage 2 conversion

FIG. 5 shows an alternative stage 2 converter using Push-Pull topology.

FIG. 6 shows a unique DC to AC buck inverter for the stage 3 conversion.

FIG. 7 shows a single ended boost-forward converter that combines stages 1 & 2.

FIG. 8 shows an alternative converter that combines stages 1 & 2.

FIG. 9 shows a simplified 2-stage DC to AC inverter combining FIGS. 6 & 7.

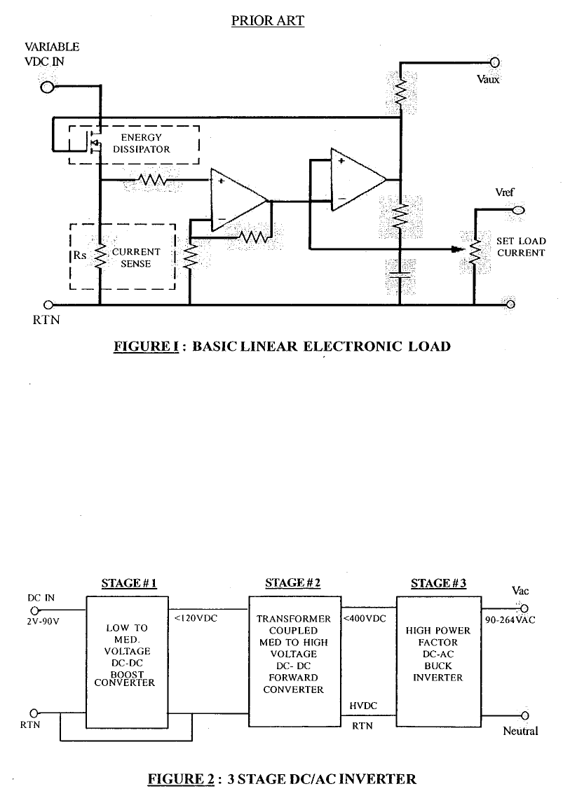

### DESCRIPTION OF INVENTION

FIG. 2 shows the block diagram of the basic invention divided into 3 stages of power conversion using high frequency switch-mode technology.

Stage 1 is a high efficiency switch-mode DC-to-DC converter. It accepts a wide range, low DC voltage and boosts it to a fixed DC voltage slightly higher than the maximum DC input voltage. The prototype was designed for a 2 VDC to 50 VDC range. This boost stage is required to handle most common power supply voltages and currents. The prototype design is limited to 500 watts and 60 amps but higher and lower power versions are covered by the invention. Circuit operation is described in the details section below for stage 1.

Stage 2 is a conventional half-bridge or push-pull, DC-to-DC converter with transformer isolation. Transformer isolation is required for the stage 3 inverter. The output voltage is set by the transformer turns ratio to a DC voltage that is higher (by approximately 5%) than the peak voltage of the AC line. Voltage mode control can be used if a conventional half-bridge converter is used for this stage. For transformer balance the alternative push-pull stage requires current mode control.

Circuit operation is described in the details section for stage 2 below.

Stage 3 is a unique DC to AC inverter that uses a Power Factor Corrector (PFC) modulator modified to deliver AC current to the power line with near unity power factor. Circuit operation is described in the details section below for stage 3.

FIGS. 7 & 8 show alternative circuits where stages 1 & 2 have been combined to reduce component count.

Circuit operation is described in the details section on combined stages 1 & 2 below.

In most cases stages 1 & 2 and the combined versions are conventional DC-to-DC converters. These input stages with transformer isolation are a pre-requisite for providing the floating high voltage source to drive the 3^{rd} stage inverter.

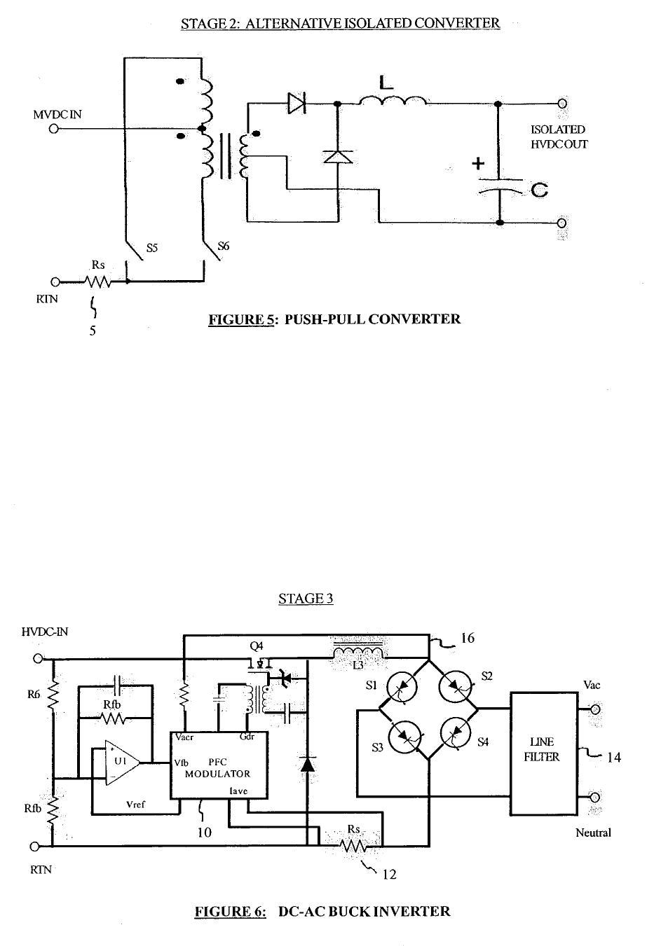

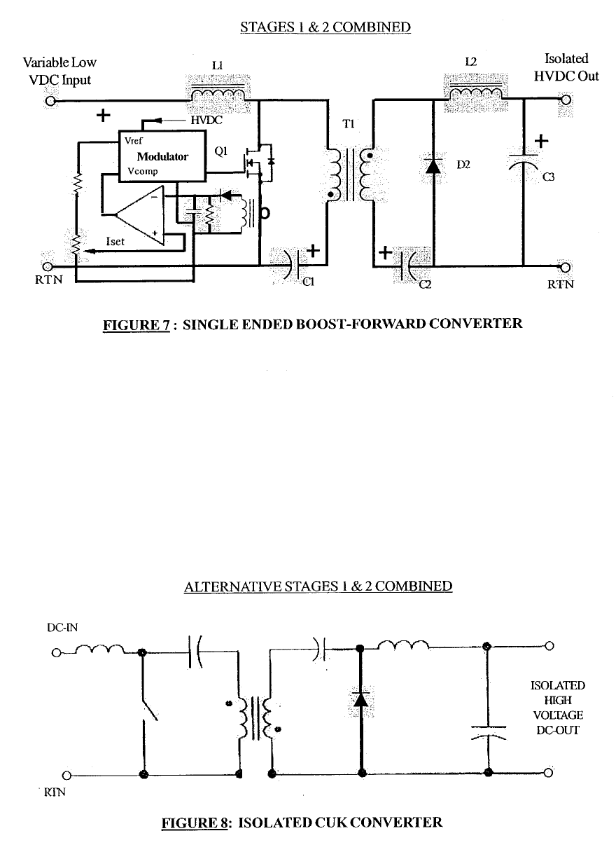

FIG. 9 shows a complete 2-stage inverter combining the boost-forward circuit of FIG. 7 with the DC to AC buck inverter of FIG. 6.

### Details of Each Stage

### Stage 1—FIG. 3

This stage is a conventional BOOST converter employing one or more high current FET switches represented by Q1. The circuit converts any low DC voltage input to a higher constant voltage. In the prototype, the output voltage was set to 55 VDC so that 60 VPK FETs could be used for Q1. D1 is a Schottky rectifier preferably rated for 50% more current than maximum rated load. A current transformer 7 or Hall effect sensors are used to sense the average input current. Current sense resistors are not recommended for detecting high currents in a high efficiency, low voltage converter.

Output voltage feedback Vfb, limits the maximum voltage to a safe operating level for the switch Q1. The current comparator 4 controls the output voltage. At turn ON, the output voltage rises under soft start or current limit control until the stage 3 inverter starts to deliver power to the AC line. The potentiometer 2 sets the input load current. The output voltage stabilizes when the pre-selected input load equals the load delivered to the AC line.

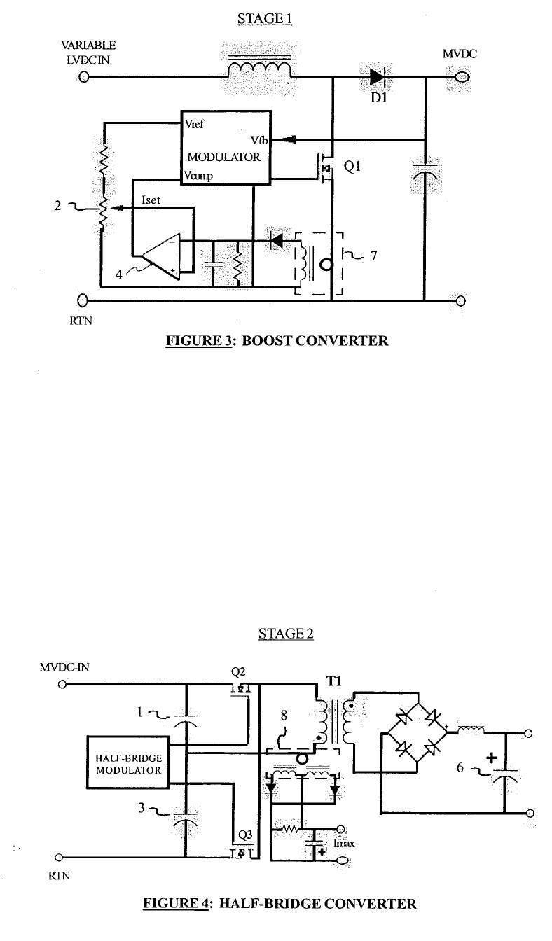

### Stage 2—FIG. 4

FIG. 4 shows a half-bridge converter. Any voltage mode half-bridge modulator can drive this converter. The field effect transistor (FET) switches Q2 and Q3 clamp the primary winding of transformer T1 at the DC input voltage by their reverse diodes. This clamping action also returns the energy in the leakage inductance to the input line and allows the use of the same voltage rated FETs as in stage 1. In practice these reverse diodes are bypassed with fast rectifiers. The circuit is an open loop square wave converter that produces an output voltage N times higher than the input voltage. N is the turns ratio of the transformer. In the prototype, the ratio was set to 55/400. This produces an output voltage of 400 VDC when the input is 55 VDC. Input capacitors 1 and 3 provide transformer balance without the need for current mode control. A current transformer 8 may be required to limit the maximum current under start up conditions. Gate drive transformers (not shown) are required to drive transistors Q2 and Q3. The storage capacitor 6 should be large enough to maintain the 120 Hz ripple below 10% of the DC voltage level at full load. This topology was chosen for the prototype unit.

### Alternative Stage 2—FIG. 5

FIG. 5 shows a conventional push-pull DC-to-DC converter with transformer isolation. The transformer has the same turns ratio as the half-bridge design but requires a bifilar wound dual primary winding. There are a variety of push-pull modulators with current mode control that provide transformer balance for this application. The push-pull circuit has the advantage that the switches S5 & S6 can be driven directly from the modulator but they must be rated for twice the voltage rating of the stage 1 switches. This design requires a current sense resistor 5 for current mode control and transformer balance. Note that primary winding snubbers are required to dissipate the energy in the leakage inductance. These limitations reduce the efficiency of the push-pull circuit and make it less desirable than the half-bridge converter.

### Stage 3—FIG. 6

FIG. 6 shows the unique DC to AC buck inverter. A modified I.C. modulator 10 that is designed for power factor correction controls the pulse width modulation of switch Q4. This modulator generates the required line frequency sinusoidal current in the inductor L3 with a power factor greater than 0.98 at full load. The connections to the modulator from the rectified AC line 16 and the average current sense resistor 12 are the same as required for power factor correction. However the high DC voltage is now the input to this circuit and the AC line is the output. For this circuit to work as an inverter the AC bridge rectifiers must be turned ON and OFF in phase with the AC line voltage. The attenuated high DC voltage to the voltage sense input Vfb of the modulator must be phase inverted so that when this voltage is less than the reference voltage the modulator is OFF. The operational amplifier U1 in FIG. 6 provides a unity gain phase inversion for the prototype design. As stated in the stage 1 description, the modulator 10 delivers power to the AC line when the high voltage DC line (HVDC) reaches operational level. This HVDC level stabilizes when the power delivered to the AC line equals the pre-selected input power.

The operational HVDC level for this circuit is: Vref*(R6+Rfb)/Rfb Volts. AC voltage detectors (not shown) are used to ensure that the gate controlled bridge rectifiers are turned on as follows:

S2 and S3 are ON when the AC voltage is positive.

S1 and S4 are ON when the AC voltage is negative.

The line filter 14 attenuates the high frequency switching noise and protects the AC power lines from electromagnetic noise pollution.

### Combined Stages 1 & 2

### FIG. 7: Single Ended Boost-Forward Converter

FIG. 7 shows a proprietary single ended boost-forward converter that combines the functions of stages 1 & 2 with a single switch. The boost circuit comprises inductor L1, transistor Q1, transformer T1, capacitors C1 & C2 and rectifier D2. The forward circuit comprises Q1, C1, T1, C2, capacitor C3, inductor L2 and D2. Energy in the primary side leakage inductance of transformer T1 will create voltage spikes that need to be clamped. The clamp voltage is determined by the rating of the transistor Q1. The clamp circuit returns part of this energy to storage capacitor C1. The high DC voltage feedback (HVDC) is provided by an opto-isolator. The clamp and opto-isolator circuits are not shown.

This topology is similar to the CUK topology with the exception that the capacitors C1 & C2 are used for energy storage and retrieval only. The energy transfer is entirely by the transformer. This topology will not work without the transformer. The principal advantages over the CUK converter are that both plates and leads of the capacitors C1 and C2 are at DC voltages. Therefore they do not generate any switching voltage spikes as occurs with the CUK converter design.

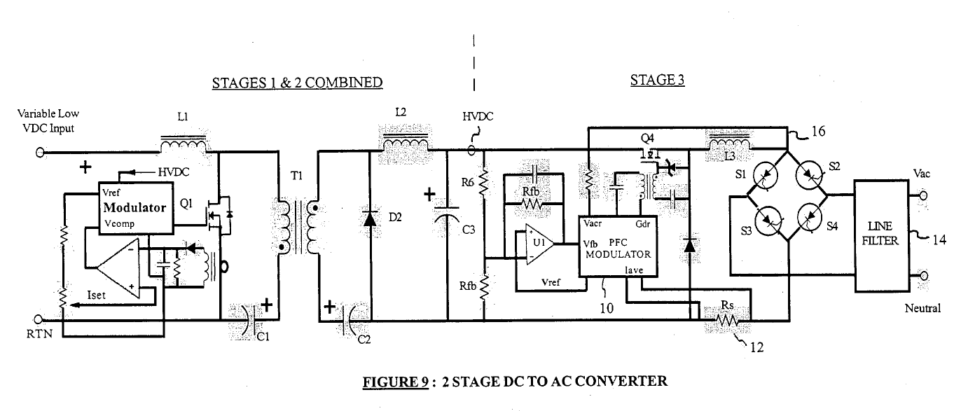

### FIG. 8: Isolated CUK Converter

FIG. 8 shows the transformer coupled CUK converter that may also be used, but the single ended boost-forward converter generates less noise and is the preferred choice.

### Two-Stage DC to AC Inverter—FIG. 9

FIG. 9 shows a complete 2-stage DC to AC inverter using the single ended boost-forward converter of FIG. 7 connected directly to the stage 3 inverter of FIG. 6. This combination has a lower component count than the 3-stage design and is more cost effective. The disadvantages are that the transistor switch Q1 and the rectifier D2 require much higher voltage ratings than the preferred 3-stage design. Hence efficiency is reduced.

### CONCLUSIONS

This invention provides a method for energy retrieval from electronic loads and other DC sources by transferring the energy from the DC power source to the AC line with near unity power factor. The technique employs high frequency switch-mode converters designed for high efficiency operation. When the DC power sources are line operated power supplies that are subjected to burn-in or testing the major portion of the energy is returned to the AC power line. Thereby the energy consumed is significantly reduced. When other DC power sources such as battery operated power supplies are subjected to burn-in or testing all the available energy is transferred to the AC line and an energy credit is due.

1. A switch-mode DC to AC power inverter that returns the major portion of the DC energy to the AC line with near unity power factor and comprises 3 stages as follows:
A first stage DC-to-DC boost converter with a wide range low voltage input.
A second stage DC-to-DC forward converter with transformer isolation and high DC voltage output.
A third stage DC to AC buck inverter controlled by a modified Integrated Circuit (IC) modulator designed for Power Factor Correction (PFC).

2. A DC to AC converter/inverter as described in claim 1 where the first and second stages are combined into a single stage boost-forward converter with transformer isolation.

3 A DC to AC converter/inverter as described in claims 1 & 2 where the modified IC modulator in the third stage inverter is replaced with an Application Specific Integrated Circuit (ASIC) modulator that includes the control signal modification provided by U1 as discussed in the stage 3 description and shown in FIG. 6.
